(19) United States
(12) Patent Application Publication
(10) Pub. No.: US 2015/0333901 A1
(43) Pub. Date: Nov. 19, 2015

(54) HIGH-SPEED SERIAL COMMUNICATION RECEIVER CIRCUIT

(71) Applicant: Dan Ozasa, Kanagawa (JP)

(72) Inventor: Dan Ozasa, Kanagawa (JP)

(73) Assignee: RICOH COMPANY, LTD., Tokyo (JP)

(21) Appl. No.: 14/685,750

(22) Filed: Apr. 14, 2015

(30) Foreign Application Priority Data
May 16, 2014 (JP) 2014-102779

(51) Int. Cl. H04L 7/04; H04B 1/16; H04L 7/00

(52) U.S. Cl. CPC H04L 7/04; H04L 7/0079; H04B 1/16

(57) ABSTRACT

A high-speed serial communication receiver circuit includes a receiver circuit which receives a high-speed differential signal generated by adding a clock signal to communication data, to convert the differential signal to a binarized input data signal, a clock data recovery circuit which synchronizes an internal clock signal with the input data signal from the receiver circuit in phase to reproduce a restored clock signal and restored communication data for output, and a controller which controls an oscillation frequency of the internal clock signal to synchronize with the input data signal in phase, and controls the oscillation frequency of the internal clock signal to be constant when the high-speed operation signal contains noise.

### CROSS REFERENCE TO RELATED APPLICATION

The present application is based on and claims priority from Japanese Patent Application No. 2014-102779, filed on May 16, 2014, the disclosure of which is hereby incorporated by reference in its entirety.

### BACKGROUND OF THE INVENTION

1. Field of the Invention

The present invention relates to a high-speed serial communication receiver circuit including a clock data recovery circuit.

2. Description of the Related Art

Conventionally, a high-speed serial communication receiver circuit including a clock data recovery circuit is known.

Japanese Patent No. 5262158 discloses such a high-speed serial communication receiver circuit which performs connection failure processing when synchronization of connection nodes based on synchronization clock is not established until a synchronization detection time defined by data transfer standard elapses from start of data reception, corrects operation of a CDR (clock data recovery) circuit, and resynchronizes the connection nodes on the basis of the synchronization clock with the corrected CDR circuit.

This high-speed serial communication receiver circuit corrects the operation of the CDR circuit when synchronization of the connection nodes is not established, making it possible to resolve a cause of error in the CDR circuit within the synchronization detection time and reduce the number of times at which the connection failure processing is performed.

However, if burst noise such as electrostatic noise enters received data during data communication, the CDR circuit follows the edges of the received data disturbed by the noise so that its phase and frequency will be out of a normal range. The CDR circuit may synchronize at an incorrect frequency even after noise disappears. In such a case the CDR circuit cannot perform data communication normally and has to restart communication.

### SUMMARY OF THE INVENTION

The present invention aims to provide a high-speed serial communication receiver circuit which can prevent a synchronization loss of a clock delivery circuit even if burst noise has entered received data.

According to one embodiment, a high-speed serial communication receiver circuit comprises a receiver circuit which receives a high-speed differential signal generated by adding a clock signal to communication data, to convert the differential signal to a binarized input data signal, a clock data recovery circuit which synchronizes an internal clock signal with the input data signal from the receiver circuit in phase to reproduce a restored clock signal and restored communication data for output, and a controller which controls an oscillation frequency of the internal clock signal to synchronize with the input data signal in phase, and controls the oscillation frequency of the internal clock signal to be constant when the high-speed operation signal contains noise.

### BRIEF DESCRIPTION OF THE DRAWINGS

Features, embodiments, and advantages of the present invention will become apparent from the following detailed description with reference to the accompanying drawings:

FIG. 1 shows the configuration of a high-speed serial communication receiver circuit according to a first embodiment;

FIG. 2 shows the configuration of a clock data recovery circuit of the high-speed serial communication receiver circuit in FIG. 1;

FIG. 3 shows the configuration of a charge pump of the clock data recovery circuit in FIG. 2;

FIG. 4 shows the configuration of a loop filter of the clock data recovery circuit in FIG. 2;

FIG. 5 shows the configuration of a voltage-controlled oscillator of the clock data recovery circuit in FIG. 2;

FIG. 6 shows the configuration of a noise detector of the clock data recovery circuit in FIG. 2;

FIG. 7 shows the configuration of an amplitude detector of the noise detector in FIG. 6;

FIG. 8 shows the configuration of a potential detector of the noise detector in FIG. 6;

FIG. 9 shows that high-speed differential signals are in a normal range;

FIG. 10 shows that amplitude of the high-speed differential signals exceeds normal values;

FIG. 11 shows that potentials of the high-speed differential signals exceed normal values;

FIG. 12 is a flowchart for the operation of a high-speed serial communication receiver circuit; and

FIG. 13 is a block diagram of the configuration of a high-speed serial communication receiver circuit according to a second embodiment.

### DETAILED DESCRIPTION OF THE PREFERRED EMBODIMENT

Hereinafter, embodiments of a high-speed serial communication receiver circuit will be described in detail with reference to the accompanying drawings. Wherever possible, the same reference numbers will be used throughout the drawings to refer to the same or like parts.

### First Embodiment

Referring to FIG. 1, a high-speed serial communication receiver circuit 10 comprises a receiver circuit 11, a clock data recovery circuit (CDR) 20, a deserializer 30, a noise detector 40, and a controller 50. The receiver circuit 11 receives high-speed differential signals R×p, R×m to output binarized received data (input data signal) rcvdata. The high-speed operation signals R×p, R×m are generated by adding a clock signal to communication data.

The clock data recovery circuit 20 receives received data rcvdata and a control signal desdata and reproduces a restored clock signal clk and restored communication data rstdata for output.

The deserializer 30 converts serial data to parallel data for output. It converts the restored clock signal clk from the clock data recovery circuit 20 to a cyclic clock signal desclk and the restored communication data rstdata to a restored data signal desdata as parallel data and outputs them.

The noise detector 40 receives the high-speed differential signals R×p, R×m and outputs noise detection signals ndet1, ndet2 when the signals R×p, R×m include noise. The controller 50 receives the cyclic clock signal desclk, restored data signal desdata, and noise detection signals ndet1, ndet2 and outputs a control signal cdropen, a cyclic clock clkp, and restored data dadtap.

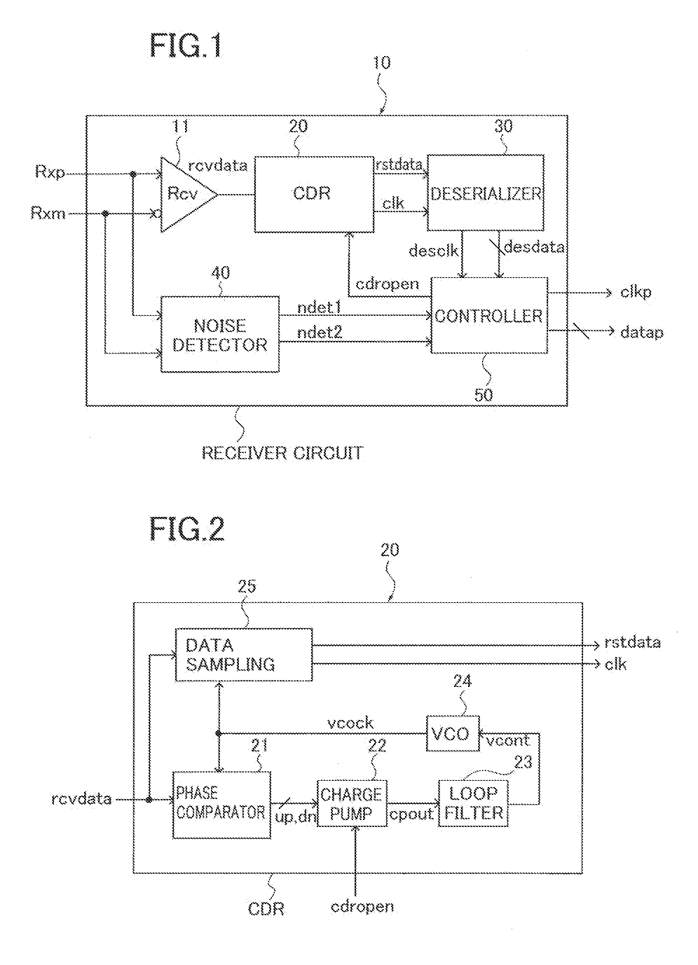

Referring to FIG. 2, the clock data recovery circuit 20 comprises a phase comparator 21, a charge pump 22, a loop filter 23, a voltage-controlled oscillator (VCO) 24, and a data sampling 25. The phase comparator 21, charge pump 22, loop filter 23, and voltage-controlled oscillator 24 constitute a negative feedback circuit. The phase comparator 21 and data sampling 25 are controlled to synchronize the phases of the received data rcvdata and internal clock signal vcock.

The clock data recovery circuit 20 is a closed-loop structure, and restores a clock and data from the received data rcvdata by synchronizing the internal clock signal vcock with the received data rcvdata in phase and frequency to output the restored clock signal clk and restored communication data rstdata.

The phase comparator 21 compares the phases of the received data rcvdata and internal clock signal vcock and outputs an UP signal up and a DOWN signal dn.

The charge pump 22 applies a current in accordance with a phase difference obtained by the phase comparator 21.

Referring to FIG. 3, the charge pump 22 is comprised of two switch elements Q1, Q2 connected in series, an OR circuit 22A and an AND circuit 22B, and inverters 11, 12. Upon receipt of the UP signal up, in the charge pump 22 the switch element Q1 turns on to apply a current to the loop filter 23. Upon receipt of the DOWN signal dn, the switch element Q2 turns on to draw the current from the loop filter 23.

The control signal cdropen is input to an input terminal 22a of the charge pump 22 from the controller 50. During a low level of the control signal cdropen, the charge pump 22 normally operates in accordance with the UP signal up and DOWN signal dn. During a high level of the control signal cdropen, the switch elements Q1, Q2 turn off so that output impedance turns to high. Thereby, the charge pump 22 stops applying the current to the loop filter 23 or drawing the current from the loop filter 23.

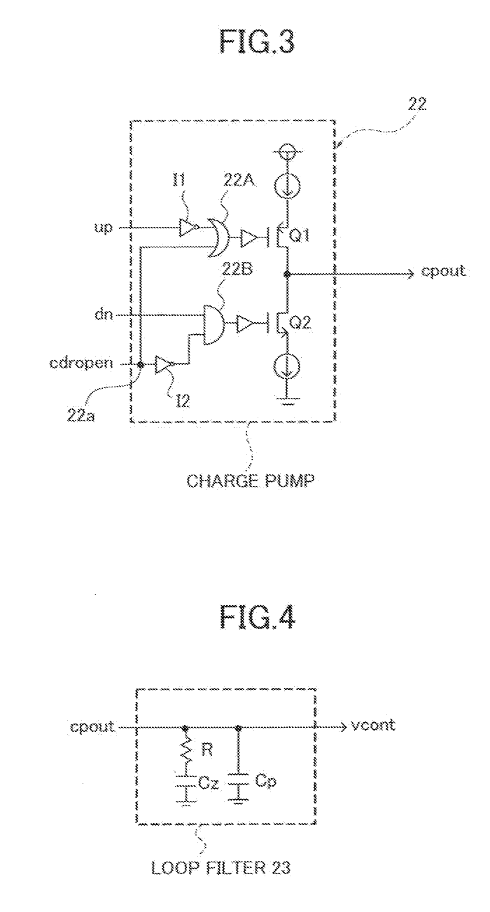

Referring to FIG. 4, the loop filter 23 is a general lag lead filter and comprises a resistance R and capacitors Cz, Cp. The loop filter 23 smoothes the current cpout output from the charge pump 22 to output a voltage vcont, and sets a zero point with the resistance R and the capacitor Cz and sets a pole with the resistance R and the capacitor Cp.

Further, the loop filter 23 holds the output voltage vcont with charges accumulated in the capacitors Cz, Cp when the clock data recovery circuit 20 is in open loop operation or the charge pump 22 is placed in a high impedance state. That is, the output voltage vcont from the loop filter 23 is fixed.

Referring to FIG. 5, the voltage-controlled oscillator 24 is a general ring type structure. It receives the output voltage vcont from the loop filter 23 as analog control voltage to oscillate the internal clock signal at a frequency according to the output voltage vcont for output.

When the output voltage vcont from the loop filter 23 is constant, the oscillation frequency of the voltage-controlled oscillator 24 becomes constant and fixed.

The data sampling 25 in FIG. 2 samples the received data rcvdata by the phase-synchronized internal clock signal vcock and outputs the restored communication data rstdata in synchronization with the restored clock signal clk.

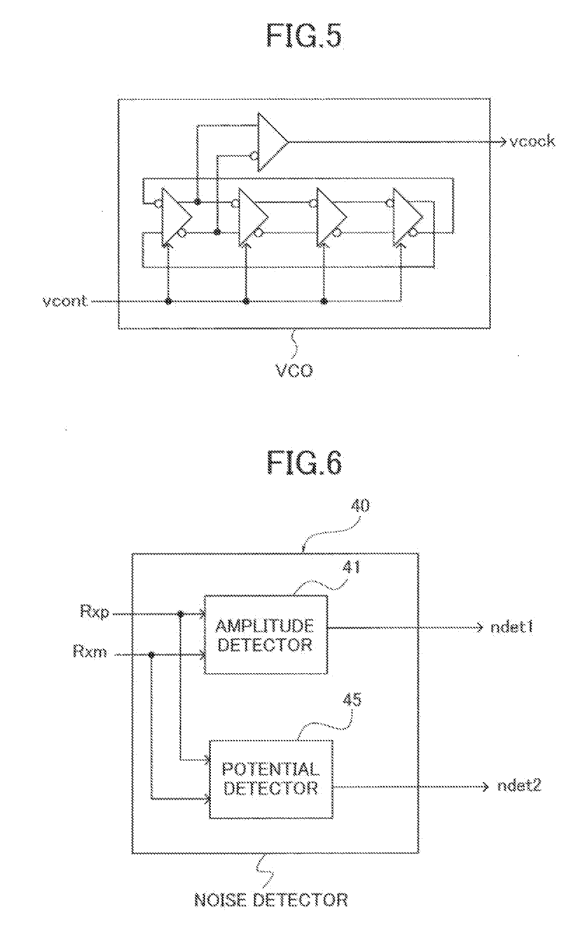

Referring to FIG. 6, the noise detector 40 comprises an amplitude detector 41 and a potential detector 45, assuming an increase in amplitude or a decrease or an increase in potential level as a result of noise in the received data. However, the noise detector 40 does not need to include both of the amplitude detector and potential detector. It can be comprised of only one of them.

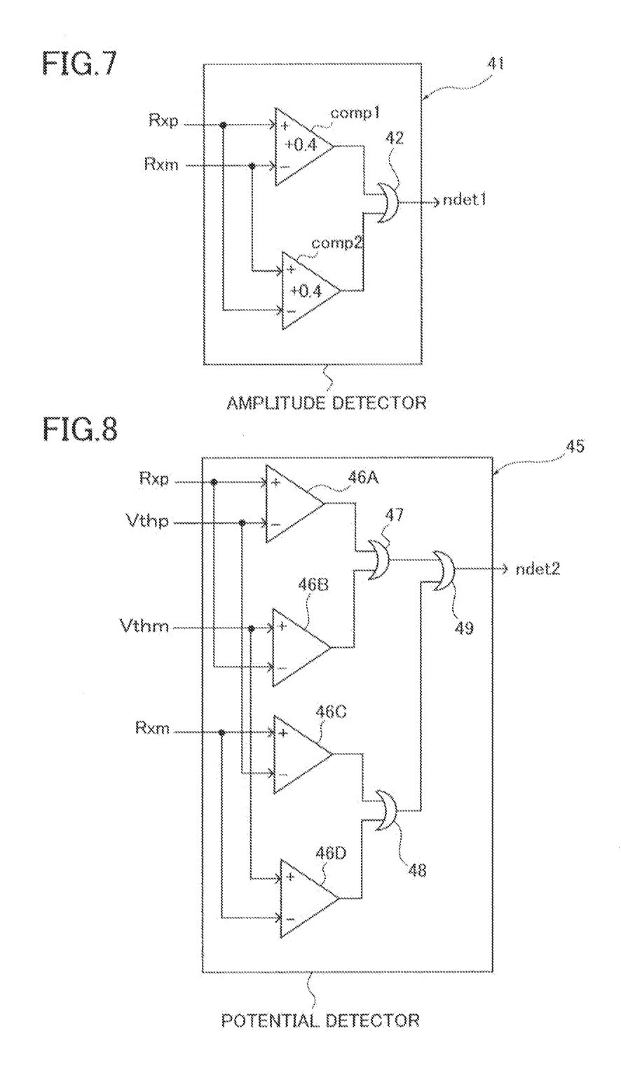

Referring to FIG. 7, the amplitude detector 41 comprises two comparators comp1, comp2 and an OR circuit 42.

The comparators comp1, comp2 are comparators having an offset. Its output terminal turns to high level when a non-inverting input terminal is higher than an inverting input terminal by 0.4V or more. The value 0.4V is merely one example, and should not to be limited.

The amplitude detector 41 outputs a noise detection signal ndet1 in high level from the OR circuit 42 when the high-speed differential signal R×p is higher than the high-speed differential signal R×m or the high-speed differential signal R×m is higher than the high-speed differential signal R×p by 0.4 V or more. This corresponds to detecting one side of amplitude at 0.4V (differential 0.8V) or more. The amplitude detector 41 can detect an increase in the amplitude of the high-speed differential signal R×p or R×m arising from burst noise having entered the high-speed differential signal.

Referring to FIG. 8, the potential detector 45 comprises four comparators 46A to 46D and three OR circuits 47 to 49. The offset of the four comparators 46A to 46D is 0V. One of the high-speed differential signals R×p, R×m and one of reference voltages Vthp, Vthm are input to the comparators 46A to 46D, as shown in FIG. 8. The reference voltages Vthp, Vthm are higher and lower threshold voltages for determining anomaly, respectively. For instance, when either or both of the high-speed differential signals R×p, R×m is/are higher than the reference voltage Vthp or lower than reference voltage Vthm, a high-level noise detection signal ndet2 is output from the OR circuit 49.

In the following the operation of the potential detector 45 is described.

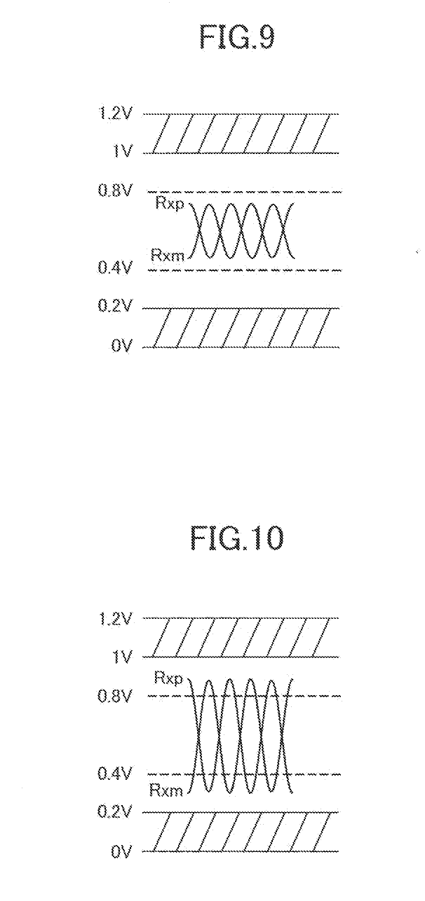

FIG. 9 shows that the high-speed differential signals R×p, R×m are in normal state. The central voltage (common voltage) of the high-speed differential signals R×p, R×m is set to 0.6V. The offset of the comparators comp1, comp2 of the amplitude detector 41 in FIG. 7 is set to 0.4V. The reference voltage Vthp is set to 1.0V as shown in FIG. 9 while the reference voltage Vthm is set to 0.2V.

The reference voltages Vthp, Vthm are properly set relative to nominal values of the high-speed differential signals R×p, R×m. In FIG. 9 the high-speed differential signals R×p, R×m are in a normal range. In this case the noise detector 40 does not operate and maintains the noise detection signals ndet1, ndet2 in low level.

Referring to FIG. 10, the amplitude of the high-speed differential signals R×p, R×m exceeds 0.4V because of burst noise. Then, the amplitude detector 41 operates and the noise detection signal ndet1 turns to high level.

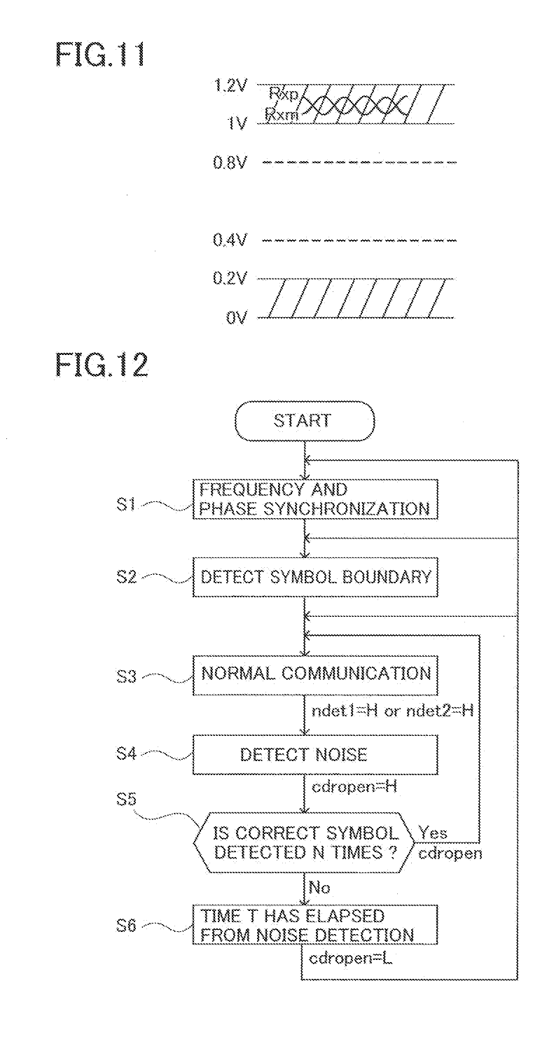

Further, referring to FIG. 11, when the potential of the high-speed differential signals R×p, R×m is higher than 1.0V or lower than 0.2V, the potential detector 45 operates and the noise detection signal ndet2 turns to high level.

Thus, the high-level noise detection signals ndet1, ndet2 can be detected when the high-speed differential signals R×p, R×m are outside the normal range due to burst noise or else.

Next, the operation of the high-speed serial communication receiver circuit 10 as configured above is described with reference to FIG. 12.

In step S1 as a general communication linkup sequence, the frequency of the restored clock signal clk is synchronized with that of the received data and the internal clock signal vcock of the clock data recovery circuit 20 is synchronized with the received data rcvdata in phase.

In step S2 symbol boundary is detected. Herein, symbol refers to one used in 8b/10b bit rate conversion of typical high-speed serial communication. Synchronous codes are preset for detecting symbol boundary. Symbol boundary is determined by detecting synchronous codes. By this symbol boundary detection, every 10b symbols are subjected to 10b/8b conversion, enabling normal data reception in step S3.

In step S4 the noise detector 40 in FIG. 6 detects noise in normal communication, that is, high-level noise detection signals ndet1, ndet2. For example, when at least either of the amplitude detector 41 and the potential detector 45 outputs the noise detection signal ndet1 or ndet2 due to burst noise, the controller 50 outputs a high-level control signal cdropen. The control signal cdropen is input to the input terminal 22a of the charge pump 22 in FIG. 3 to turn off the switch elements Q1, Q2 of the charge pump 22. Thereby, the output impedance of the charge pump 22 turns to high, placing the clock data recovery circuit 20 in open loop state.

By the turning-off of the switch elements Q1, Q2, the charge pump 22 stops applying the current to the loop filter 23 or drawing the current therefrom. Thereby, the output voltage vcont becomes constant by charge accumulated in the capacitors Cz, Cp of the loop filter 23. Thus, the oscillation frequency of the voltage-controlled oscillator 24 also becomes constant. Thus, the clock data recovery circuit 20 can be free from an influence from the noise in the received data rcvdata and prevented from synchronization loss.

If the noise is eliminated while the voltage-controlled oscillator 24 oscillates at constant frequency, the clock data recovery circuit 20 may be able to receive data properly again. For example, in step S5 it is determined that the received data is not affected by noise when a correct symbol is detected N (N=arbitrary number) times consecutively. Then, the controller 50 outputs a low-level control signal cdropen and returns to the normal communication in step S3.

When a correct symbol is not detected N times consecutively, that is, a symbol error occurs consecutively (NO in step S5), the flow proceeds to step S6.

Even with no noise in the received data, there is a possibility that frequency deviations and phases of the received data and restored clock may shift from each other, hindering receipt of a correct symbol. In step S6 time T (T is arbitrary time) from the noise detection is measured. When the time T has passed, the clock data recovery circuit 20 synchronizes the received data and restored clock in phase again. With the phase synchronization established, the controller 50 returns the control signal cdropen to low level and returns to the normal communication in step S3.

Further, a symbol boundary may be displaced although phase synchronization is maintained. In this case a symbol boundary has to be detected again, so that the flow returns to step S2.

In this communication system synchronous codes for symbol boundary detection are transmitted/received with a constant interval T2 (T2 is arbitrary time) between transfers of normal data, taking occurrence of synchronization loss into account. Because of this, if only frequency synchronization and phase synchronization are established, it is possible to detect a symbol boundary and return to normal communication after a lapse of the constant time T2. No detection of a symbol boundary after the time T2 may signify that the frequency synchronization of received data and restored clock has not been established or they are synchronized at incorrect frequency. In this case the flow returns to step S1, to perform frequency synchronization again.

### Second Embodiment

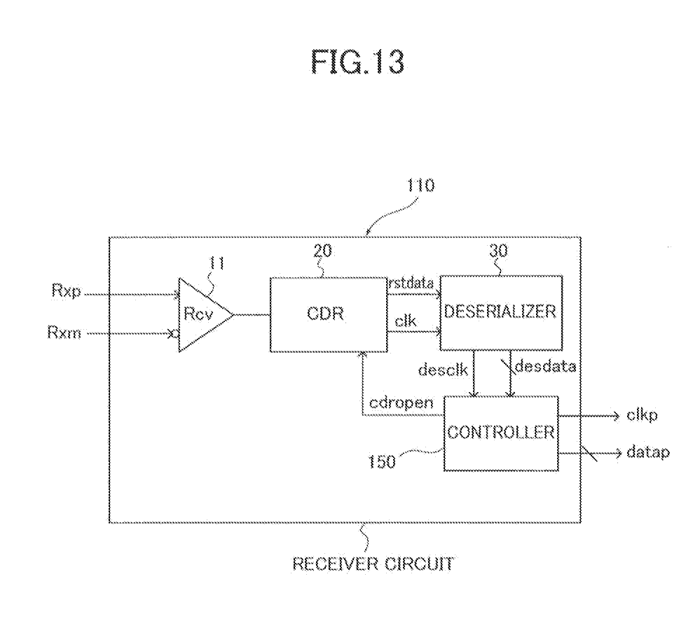

FIG. 13 shows the configuration of a high-speed serial communication receiver circuit 110 according to a second embodiment.

The high-speed serial communication receiver circuit 110 comprises a receiver circuit 11, a clock data recovery circuit (CDR) 20, a deserializer 30, and a controller 150. A difference from the high-speed serial communication circuit 10 according to the first embodiment is in that this receiver circuit 110 omits the noise detector 40 and the controller 150 functions to detect noise in place of the noise detector.

The controller 150 decodes a 10-bit symbol into 8-bit data (10b/8b conversion) in normal communication. In 10b/8b conversion the number of 10-bit combinations is larger than that of 8-bit combinations so that some 10-bit combinations have no corresponding 8-bit data. At an occurrence of a bit error in a communication error, such 10-bit combinations having no corresponding 8-bit combinations can be detected as a symbol error. A symbol error may also occur in normal communication. For instance, two consecutive symbol errors suggest some kind of anomaly.

In this case assumed that received data contains noise, noise detection in step S14 of FIG. 12 is performed. The high-speed serial communication receiver circuit 110 according to the second embodiment can exclude the noise detector 40, facilitating circuit configuration.

For another example, the high-speed serial communication receiver circuit 10 in FIG. 1 can be combined with the controller 150 in FIG. 13. Thereby, both of the noise detector and the controller can attend to the noise detection. Noise entry to the received data can be dealt with in terms of analog voltage and digital data so that noise can be more certainly detected.

As described above, upon detecting noise in the received data, the frequency of the restored clock is controlled to be constant. This makes it possible to prevent synchronization loss of the clock data recovery circuit 20 due to the noise and recover to normal communication.

However, data error may still occur by the very first noise. In such a situation error can be corrected by using an error correction code such as a known Reed-Solomon error correction code, as long as the number of errors is within a certain number defined in theory, although communication data becomes redundant by parity symbol.

Thus, an error correction code is added to a high-speed differential signal (communication data). The high-speed serial communication receiver circuits 10, 110 each additionally comprise an error corrector to correct an error in accordance with the added error correction code.

Further, interleave function can be additionally provided to deal with consecutively occurring burst noise which may not be corrected by the error correction. Communication data is rearranged in compliance with a certain rule by the interleave function. Thereby, consecutive errors can be dispersed to greatly increase a range correctable by the error correction.

Thus, communication data is interleaved. The high-speed serial communication receiver circuits 10, 110 each additionally comprise a deinterleave processor to deinterleave the interleaved communication data to original communication data.

As described above, it is made possible to prevent synchronization loss of the crock data recovery circuit even if noise enters in received data, and reduce the occurrence of communication error with the error correction code and interleave function.

Although the present invention has been described in terms of exemplary embodiments, it is not limited thereto. It should be appreciated that variations or modifications may be made in the embodiments described by persons skilled in the art without departing from the scope of the present invention as defined by the following claims.

What is claimed is:

1. A high-speed serial communication receiver circuit comprising:
a receiver circuit which receives a high-speed differential signal generated by adding a clock signal to communication data, to convert the differential signal to a binarized input data signal;
a clock data recovery circuit which synchronizes an internal clock signal with the input data signal from the receiver circuit in phase to reproduce a restored clock signal and restored communication data for output; and
a controller which controls an oscillation frequency of the internal clock signal to synchronize with the input data signal in phase, and controls the oscillation frequency of the internal clock signal to be constant when the high-speed operation signal contains noise.

2. The high-speed serial communication receiver circuit according to claim 1, wherein
the controller determines that the high-speed operation signal contains noise when a symbol error occurs a plurality of times consecutively during a bit rate conversion.

3. The high-speed serial communication receiver circuit according to claim 1, further comprising
a noise detector which detects noise in the high-speed differential signal, wherein
the controller controls the oscillation frequency of the internal clock signal to be constant when the noise detector detects noise in the high-speed differential signal.

4. The high-speed serial communication receiver circuit according to claim 3, wherein
the clock data recovery circuit comprises
a phase comparator which compares phases of the input data signal and the internal clock signal,
a charge pump which outputs a current in accordance with a phase difference obtained by the phase comparator,
a loop filter which smoothes the current output from the loop filter to an output voltage for output, and
a voltage-controlled oscillator which oscillates the internal clock signal at a frequency in accordance with the output voltage from the loop filter for output, wherein
the controller controls an output impedance of the charge pump to be high to control the output voltage from the loop filter to be constant, when the noise detector detects the noise.

5. The high-speed serial communication receiver circuit according to claim 1, wherein the communication data is added with an error correction code, the high-speed serial communication receiver circuit further comprising
an error corrector which corrects an error according to the added error correction code.

6. The high-speed serial communication receiver circuit according to claim 1, wherein the communication data is interleaved, the high-speed serial communication receiver circuit further comprising
a deinterleave processor which deinterleaves the interleaved communication data to original communication data.
